(19) United States
(12) Patent Application Publication
(10) Pub. No.: US 2014/0350887 A1
(43) Pub. Date: Nov. 27, 2014

(54) METHOD FOR CHARACTERIZATION OF A SURFACE TOPOGRAPHY

(71) Applicant: COMMISSARIAT A L'ENERGIE ATOMIQUE ET AUX ENE ALT, Paris (FR)

(72) Inventors: Carlos BEITIA CACERES, Noyarey (FR); Florent DETTONI, Grenoble (FR)

(73) Assignee: COMMISSARIAT A L'ENERGIE ATOMIQUE ET AUX ENE ALT, Paris (FR)

(21) Appl. No.: 14/276,302

(22) Filed: May 13, 2014

(30) Foreign Application Priority Data
May 24, 2013 (FR) 13 54687

(51) Int. Cl. G01B 21/20

(52) U.S. Cl. CPC G01B 21/20
USPC 702/167

(57) ABSTRACT

A method for characterization of a surface topography, comprising application of the following steps:
measurement of the surface topography;
first fitting of data output from the measurement of the surface topography, made from an order m first equation;
filter height of data output from application of the first fitting;
determine the data fitting coefficients for data output from the application of filtering, from an order n second equation;
second fitting of data output from application of the first fitting, made from the order n second equation and previously determined coefficients;
n and m being positive integers greater than or equal to 1 and such that n≧m.

### TECHNICAL FIELD

The invention relates to the field of metrology, and particularly the characterization of surface topographies. The invention is advantageously applicable to the microelectronic field in order to characterize surfaces of microelectronic devices such as electronic chips, but also other fields making use of setting up topography over large distances, for example for earth mapping.

### PRIOR ART

The topography of a surface, in other words the relief of this surface, can be characterized using different measurement techniques such as mechanical profilometry, Atomic Force Microscopy (AFM), Scanning Electron Microscopy (SEM), Transmission Electron Microscopy (TEM) and scatterometry. These measurement techniques may be used to make measurements in two dimensions (2D), in other words measurements of the height of the relief along a direction on the surface to be characterized, or measurements in three dimensions (3D), in this case measuring the height of the relief in a plane of the surface to be characterized.

Measurements made with these techniques are usually made on a small part of the surface of which the topography is to be characterized. However, there are several disadvantages with the application of these techniques with a limited acquisition size:
the topographic information obtained is limited to specific areas of the surface,
the measurements made are point measurements that give no information about the environment of the characterized area, in other words about the topography around the part of the surface on which the measurements are made,
the measurements are necessarily made on a part of the surface corresponding to a “simple” structure with a fixed size and density.

For example, chemical-mechanical polishing of a surface of an electronic chip is usually monitored and controlled by topography measurements made on solid patterns called “Test-Boxes” on this surface, corresponding to rectangular parts for example with a section equal to 100 μm×70 μm. However these measurements that are usually made over a length of about 200 μm in 2D or over an area equal to about 0.01 mm² in 3D are not always representative of the global topography of the entire polished surface of the chip. Chemical-mechanical polishing and other fabrication techniques in the microelectronics field, are strongly dependent on the size and density of patterns on the treated surface, in other words elements present on the surface for example such as interconnection lines or contact pads, and neighbourhood effects. Consequently, such measurements cannot identify topography variations induced by variations of the density or size of the patterns, or neighbourhood effects on the characterized surface. An increase in the criticality of some microelectronics fabrication techniques such as chemical-mechanical polishing has made these limitations problematic for the development of electronic chips in future technological nodes.

One solution to these problems consists of making topography measurements over larger areas, for example corresponding to measurements over lengths longer than about 1 mm in 2D and over areas larger than about 1 mm² in 3D, in the microelectronics field. Different techniques such as mechanical profilometry, interferometric microscopy or confocal microscopy make it possible to characterize the topography for such areas with a vertical resolution (dimension along which measured variations of the topography extend) of the order of one nanometer and a lateral resolution (in the plane of the characterized surface) of the order of one micrometer.

However, other problems arise in this case. Measurement equipment used in this case provides raw measurement data including variations related to unwanted topographic contributions, in other words height variations that do not form part of the topography to be characterized. Most of the time, these unwanted topographic contributions are related to the measurement equipment and are accentuated as the acquisition size increases. These unwanted topographic contributions may for example be due to deformations of the element of which the surface is being characterized, to non-flatness of the support on which the element is placed during the measurement, to the principle of the measurement technique used, to measurement artefacts (particularly in the case of optical measurement techniques), etc. A typical example of an unwanted topographic contribution is non-flatness of the support on which the element is placed during the measurement, which usually induces a linear inclination or slope in the plot of values of raw measurement data.

On the micrometric scale, there are several ways of deleting these variations related to unwanted topographic contributions in the measurement data. For example, it would be possible to make a polynomial fit of measurement data, for example consisting of determining a polynomial, for example order 1 to 3, by regression from measurement data and subtracting the polynomial obtained from raw measurement data. This may be done on all measurement data or only on one or some parts of the measurement data specified manually by the user. Unwanted frequencies corresponding to unwanted topographic contributions in the frequency space of the measurement data can also be filtered directly.

However, in the case of topographic measurements made for large areas, polynomial fitting is done not only on unwanted topographic contributions but also on patterns of the characterized surface that are not to be modified or deleted from the measurement data. Therefore such polynomial fitting eliminates topography variations related to unwanted topographic contributions that affect measurement data, but also variations of topography related to patterns or relief elements of the characterized surface. Furthermore, polynomial fitting located only on some zones is not even applicable in practice to large areas because these zones are too numerous and too small to be correctly selected. Finally, the fact of directly doing frequency filtering of variations related to unwanted topographic contributions in the frequency space of measurement data is also not possible in the case of large areas because a frequency related to one of these unwanted topographic contributions may correspond to a frequency characteristic of the presence of patterns. Eliminating this frequency would also eliminate variations of these patterns, which is not desirable.

### PRESENTATION OF THE INVENTION

Thus there is a need to propose a method for characterization of a surface topography that can be applied equally for small areas and for large areas, and capable of eliminating and/or attenuating variations related to unwanted topographic contributions appearing in topographic surface measurements without affecting or only slightly affecting other measured topographic variations, particularly of patterns which may be present at the surface of which the topography is characterized.

To achieve this, one embodiment discloses a method for characterization of a surface topography, comprising at least application of the following steps:
measure the surface topography;
first fitting of data output from the surface topography measurement, made from an order m first equation;
filter data output from application of the first fitting, eliminating some of the data output from application of the first fitting the values of which are greater than a maximum value and/or less than a minimum value;
determine the data fitting coefficients for data output from the application of filtering, from an order n second equation;
second fitting of data output from application of the first fitting, made from the order n second equation and previously determined coefficients;
n and m are positive integers greater than or equal to 1 and such that n≧m.

Thus, the first fitting applied in this method makes a first “flattening” of topographic measurement data to eliminate coarse unwanted topographic contributions. The filtering step applied can then reduce or eliminate the weight of patterns within these data (corresponding to the largest and/or the smallest values in these data that are greater than and/or less than values of the topography for the remainder of the surface), by eliminating a maximum number of points representing their presence within the data. Fitting coefficients are then determined from these filtered data so that these coefficients can then be used to carry out a second fitting with an equation with an order higher than or equal to the order of the equation used for the first fitting, on data output from the first fitting (therefore which have not been filtered) and thus perform a second “flattening” only on variations related to topographies other than the patterns. The filter step and the step to determine fit coefficients do not affect data that were used to make the second fitting. Therefore the second fitting makes at least a “correction” of the first fitting so that the patterns are not included in the global fitting (first fitting+second fitting) made during this method.

Unlike a simple polynomial fit made on the measurement data that is incapable of increasing the degree of the polynomial used for this fitting without also fitting the patterns, this method makes it possible to use a much higher degree or order of equation during the second fitting than would be possible in a single fitting of the measurement data, and thus to make a much more accurate global fitting of measurement data, due to the filter step used.

The surface of which the topography is being characterized may correspond to at least part of a face of an electronic chip comprising patterns. The patterns present on the characterized surface may correspond to elements with thicknesses or heights greater than those on other surface topographies, these other topographies being located on a main plane of the characterized surface and possibly corresponding to roughnesses of the characterized surface.

The measurement of the surface topography may be made in two dimensions over a length greater than or equal to about 1 mm and/or such that the ratio between said length and a spatial sampling value of the measurement (in other words in this case the distance between two measurement points) is greater than or equal to about 1 000 (for example in the microelectronics field, over a length greater than or equal to about 1 mm with a spatial sampling less than or equal to about 1 μm), or in three dimensions over an area greater than or equal to about 1 mm² and/or such that the ratio between said area and a spatial sampling value of the measurement (in this case the area between two measurement points) is greater than or equal to about 1 000 000 (for example in the microelectronics field, over an area greater than or equal to about 1 mm² with spatial sampling less than or equal to about 1 μm²). In this case the process is used over large areas.

The first fitting and/or the determination of the coefficients may be made by regression, for example using the least squares method.

The first equation and/or the second equation may be polynomials or other types of equations such as sine or cosine type equations. The use of polynomials in particular makes it possible to perform the first fitting and/or the second fitting by interpolation using any function.

The parameters n and m may be such that m∈[1,·10] and/or n∈[1,·20].

The method may also include the use of a step to reduce the resolution of data output from the filtering step between the filtering step and the step to determine fitting coefficients, the step to determine fitting coefficients possibly being applied using data with a reduced resolution. This step to reduce the data resolution enables that the execution time necessary for the processing using this method can be reduced for a given computer power, or for a given execution time, the method can be used with lower capacity calculation means or lower computer power. Such a step to reduce the data resolution is advantageously used when these data contain a very large number of points, for example when the surface topography is measured in three dimensions.

The reduction of the data resolution may be applied with a reduction factor of between about 2 and 100, in other words such that the data for which the resolution was reduced contain between about 2 and 100 times fewer measurement points than the initial data.

The steps of the method between filtering and the second data fitting may be applied one or several times using data output from a previous application of the second data fitting. Such repetition of these steps can refine the global fitting obtained by use of the method. Furthermore, if a minimum execution time is required, high values of the degrees or orders of the equations used for the first fitting and the second fitting during the first use of these steps can be chosen (for example m=5 and n=15 for a characterized area of about 9 cm²). In this case for the first data fitting, data can be filtered more efficiently later, and therefore the degree or order of the equation used for the second data fitting can be increased. And for the second data fitting, the number of iterations of steps of the processing used with this method can be reduced and therefore the global computer time required for the processing can be reduced. Therefore, the user evaluates a good compromise between calculation speed and an increase in the risk of error due to the use of degrees or orders that are too high during the first application of the first fitting and the second fitting.

The surface topography measurement may be made in two or three dimensions using at least one of the following measurement techniques: mechanical profilometry, atomic force microscopy, interferometric microscopy, confocal microscopy.

One embodiment also relates to a device for characterization of a surface topography comprising means of application of the method as defined above.

Another embodiment also relates to a device for characterization of a surface topography comprising a device for measuring the surface topography and one or several computers or calculation units for performing the steps of the method as defined above.

It is also disclosed a device for characterization of a surface topography, comprising at least:
measurement device of the surface topography;
first fitting means of data output from the measurement of the surface topography, from an order m first equation;
filtering means of data output from application of the first fitting, eliminating some of the data output from application of the first fitting the values of which are greater than a maximum value or less than a minimum value;
means for determining the data fitting coefficients for data output from the application of filtering, from an order n second equation;
second fitting means of data output from application of the first fitting, from the order n second equation and coefficients determined by application of the previous determination step;
n and m being positive integers greater than or equal to 1 and such that n≧m.

### BRIEF DESCRIPTION OF THE DRAWINGS

This invention will be better understood after reading the description of example embodiments given purely for information and in no way limitative with reference to the appended drawings in which:

FIG. 1 shows a diagram of steps of a method of characterizing the topography of a surface according to a particular embodiment;

FIGS. 2 to 6 show examples of data output from different steps of the surface topography characterization method according to a particular embodiment;

FIGS. 7 to 10 show examples of topographic data obtained after processing using a fitting method according to prior art and by the characterization method according to a particular embodiment;

FIG. 11 shows a device that can carry out a surface topography characterization method according to a particular embodiment.

Identical, similar or equivalent parts of the different figures described below have the same numeric references to facilitate the comparison between the figures.

The different parts shown in the figures are not necessarily at the same scale, to make the figures more easily readable.

The different possibilities (variants and embodiments) should be understood as not being mutually exclusive and they can be combined with each other.

### DETAILED PRESENTATION OF PARTICULAR EMBODIMENTS

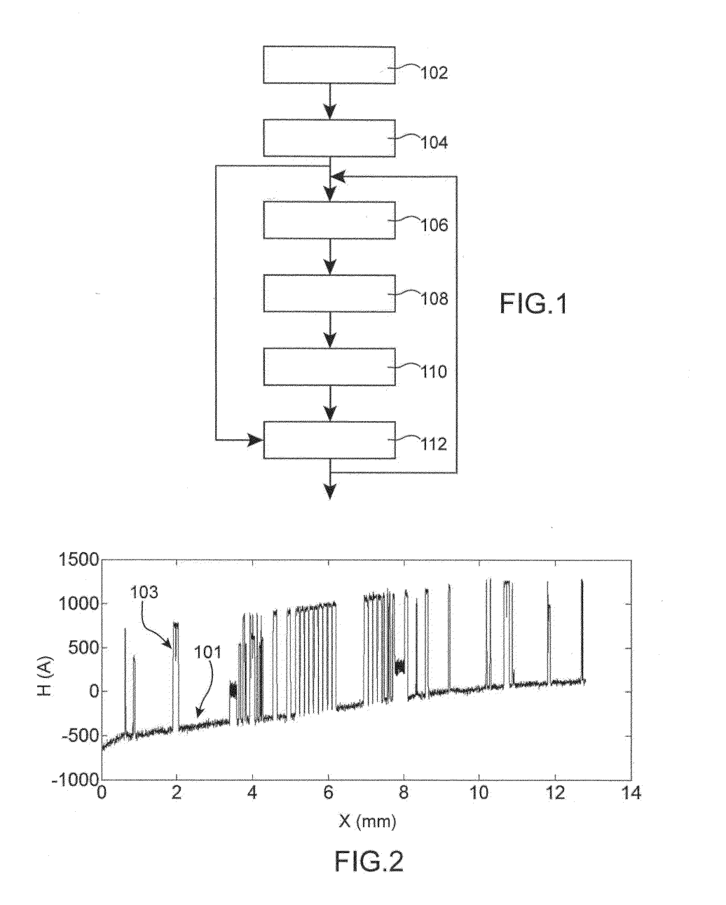

Refer firstly to FIG. 1 that shows a diagram of the steps of a surface topography characterization method according to one particular embodiment. In this example, the surface for which the topography is characterized corresponds to one face of an electronic chip on which there are several patterns such as contact pads and metallic interconnection lines.

During a first step 102, the topography of the surface to be characterized is measured. This measurement may be made in 2D or in 3D, for example by mechanical profilometry, by atomic force microscopy, by interferometric microscopy, by confocal microscopy or by any other appropriate 2D or 3D topography measurement technique. Therefore the data obtained correspond to measurements of the height H or thickness as a function of a position X along a length over which the measurement is made in the case of a 2D measurement (denoted H(X)), or measurements of the height H or thickness as a function of a position (X,Y) on the surface over which the measurements are made (denoted H(X,Y)). Furthermore, in this case this measurement is made over a large area, in other words over a length X greater than or equal to about 1 mm for a 2D measurement or over an area (X,Y) greater than or equal to about 1 mm² for a 3D measurement. The measurement data obtained are called raw data because they are unprocessed data output by the topographic measurement instrument.

FIG. 2 shows examples of raw measurement data obtained by mechanical profilometry, with a radius of curvature of the measurement tip equal to about 2 μm, made over a measurement length of slightly more than 12 mm and with a lateral resolution of about 4 μm. These raw data correspond to the measured height H (in Angstroms) over a certain length X (in millimetres) scanned along the surface to be characterized. FIG. 2 shows that the measured data illustrate small variations in the height H equal to a few Angstroms or a few tens of Angstroms over the entire characterized surface, corresponding to the surface roughness (for example variations shown by reference 101 in FIG. 2), and larger height variations H equal to a few hundred Angstroms corresponding to the patterns present on the characterized surface (for example variations shown by reference 103 in FIG. 2). There are also small roughness variations present at the top of these patterns. It can be seen on the plot shown in FIG. 2 that the measurements made include an unwanted topographic contribution corresponding to non-flatness of the support on which the chip is placed, which results in a linear inclination of the plot of values of raw topography measurement data. There is also the measurement noise in these data corresponding to small variations of the height H indistinguishable from the roughness. There is also a cylindrical type unwanted topographic contribution due to the large acquisition area relative to the deformation of the sample. Finally, other finer deformations can also be seen at the edges of the plot.

A second step 104 corresponding to a first fitting of raw data output from the first step 102 is then applied. A fitting step consists of determining firstly the coefficients of a chosen equation (that can be arbitrary) characterizing a certain geometric shape, fitting this shape as closely as possible to the data to be fitted. For example, this fitting is made by regression, for example using the least squares method. In this case, the objective is to reduce the sum of the squares of distances between points of the equation generated by the fitting and points corresponding to data to be fitted. Once the coefficients of the equation have been determined, values obtained from this equation are subtracted from the raw data values.

In this case, the equation chosen for this first fitting 104 is a polynomial. The purpose of this first fitting 104, called a polynomial fitting in this case, is to:
determine the coefficients (a₀, a₁, a₂, . . . , aₘ) of the polynomial of the type:
f(x)=a₀+a₁x+a₂x²+. . . +aₘx^{m} in the case of data output from a 2D topographic measurement,
determine the coefficients (a₀, a₁, a₂, . . . , aₚ) of the polynomial of the type:
f(x,y)=a₀+a₁x+a₂y+a₃xy+. . . +aₚx^{m}y^{m} in the case of data output from a 3D topographic measurement.

The value of the parameter m corresponds to the order or degree of the polynomial and therefore the order of the fitting made. In the case of data output from a 2D topographic measurement, an order 1 polynomial corresponds to a straight line, and in the case of data output from a 3D topographic measurement, an order 1 polynomial corresponds to a plane.

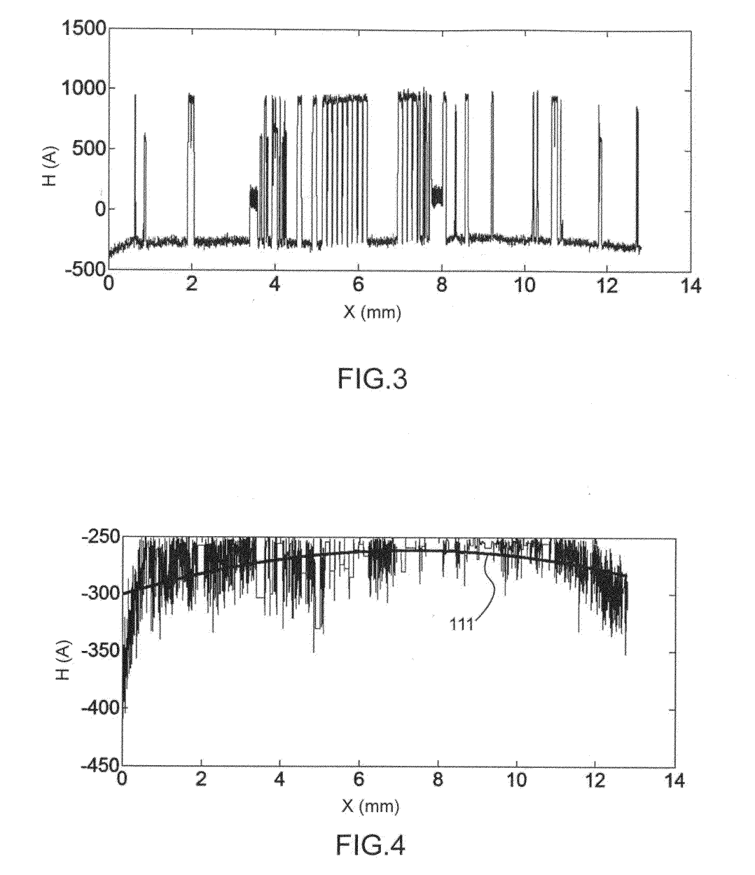

This first data fitting 104 is applied with a low order equation, for example with m between 1 and 10. Thus, this first fitting 104 can be used to “flatten” raw topographic data for the first time in order to eliminate manifest unwanted topographic contributions, in other words the slope due to the inclination of the sample for which the surface is characterized in the example described herein. In order to eliminate this inclination, this first fitting 104 will for example be applied so as to make an order 1 polynomial fitting such that slope to be eliminated can be approximated by an order 1 polynomial, namely a straight line. The data output from this first fitting 104 are shown in FIG. 3. Compared with the raw data in FIG. 2, it can be seen on FIG. 3 that this first fitting 104 has eliminated a large part of the parasite slope present in the measurement data due to the inclination of the surface during the measurement.

The order of the polynomial used for this first fitting 104 of the data (and by extension the polynomial interaction terms x/y, in other words the coefficients of the equation that depend on the variables x and/or y of the equation) is chosen as a function of the size of the zone to be fitted and therefore the characterized length or area, and the sample type. For example, for a very large acquisition size, for example longer than or equal to about 1 cm for a 2D measurement or larger than or equal to about 9 cm² for a 3D measurement and a strongly constrained and therefore highly deformed sample, this first fitting 104 can be made with an order 3 polynomial. As a variant, an equation other than a polynomial can be used during this first fitting 104. It is thus possible to use a sine or cosine type equation such as:

f(x)=a₀+a₁ cos(a₂x+a₃) or f(x)=a₀+a₁ sin(a₂x+a₃) in the case of data output from a 2D topographic measurement, or
f(x,y)=a₀+a₁ cos(a₂x+a₃y+a₄) or f(x,y)=a₀+a₁ sin(a₂x+a₃y+a₄) in the case of data output from a 3D topographic measurement.

The above equations are order 1 sine or cosine type functions. However, sine or cosine type functions with order m greater than 1 in the following form can be used:

f(x)=a₀+a₁ cos(a₂x+a₃)+a₄ cos²(a₅x+a₆)+. . . +a_{q-2} cos^{m}(a_{q-1}x+a_{q}) or

f(x)=a₀+a₁ sin(a₂x+a₃)+a₄ sin²(a₅x+a₆)+. . . +a_{q-2} sin^{m}(a_{q-1}x+a_{q})

in the case of data output from a 2D topographic measurement, or

f(x,y)=a₀+a₁ cos(a₂x+a₃y+a₄)+a₅ cos²(a₆x+a₇y+a₈)+. . . +a_{q-3} cos^{m}(a_{q-2}x+a_{q-1}y+a_{q}) or

f(x,y)=a₀+a₁ sin(a₂x+a₃y+a₄)+a₅ sin²(a₆x+a₇y+a₈)+. . . +a_{q-3} sin^{m}(a_{q-2}x+a_{q-1}y+a_{q})

in the case of data output from a 3D topographic measurement.

Thus, the type of equation used and the order m of this equation may be chosen as a function of the type of the unwanted topographic contribution(s) that is (are) to be eliminated during this first fitting 104. In particular, these parameters may be chosen and applied in exactly the same way for a particular family of measurements (same sample type, same acquisition size, etc.). Furthermore, the order m of the fitting made may also be chosen as a function of available calculation resources and the calculation time available for application of this step.

As explained above for fitting methods according to prior art, this polynomial fitting is made not only on unwanted topographic contributions but also on patterns of the characterized surface. Subsequent steps of the method described below will correct this fact.

After the second step 104 of fitting has been applied with a small order equation m, a third step 106 is applied to filter fitted data output from the second step 104. This filtering 106 is applied in order to eliminate variations related to the presence of patterns, therefore corresponding to the large peaks of several hundred Angstroms that can be seen in FIG. 3. This corresponds to filtering the height of the fitted data output from the first fitting 104. This filtering is done by defining a maximum and/or a minimum value beyond which said measurement points are ignored, in order to eliminate patterns located above and/or below a reference plane of the characterized surface depending on the type of the characterized surface. This is done by filtering the height of the data, to keep only measurement points corresponding to the “roughness” of the characterized surface on the reference plane. Filtered data output from this third step 106 of filtering are shown in FIG. 4. In this example, only measurement points with values greater than −250 Angstrom are kept. When the method is applied in the microelectronics field, filtering of the height can eliminate measurement points with values equal to a few nanometers or a few tens of nanometers higher than and/or lower than other points on the reference plane of the characterized surface. The value(s) of the maximum and/or minimum height to be eliminated can be chosen as a function of the type of patterns present on the characterized surface, and can be applied identically for a particular family of measurements, in other words for surfaces with patterns with a similar nature.

After the third step 106 of filtering, a fourth step 108 is applied to reduce the resolution of filtered data output from the third step 106. Topographic measurements made over long distances or large areas generate a large number of measurement points (for example about 64 million measurement points for an area of about 9 cm²). Furthermore, unwanted topographic contributions remaining to be fitted during a second fitting in the method correspond to height variations over long distances or large areas. Therefore, the number of points to be processed can be reduced without having an impact on the final result.

Therefore this step 108 to reduce the resolution of filtered data makes it possible to make a subsequent second fitting on these data, with an order higher than the order that could be made from data if the resolution had not been reduced, for a given computer capacity. For example, without changing the resolution, the order of the polynomial used for application of a second fitting made with an ordinary computer, for example with 2 GB RAM, would be limited to about 6 for a characterized area of about 9 cm² (namely about 64 million measurement points). By reducing the resolution of the data, for example by a factor of between about 2 and 100 and for example equal to 64, the order of this second fitting may be increased by several tens of degrees. Furthermore, in an industrial production context, a reduction in the data resolution can increase the processing speed of the method and therefore increase the production rate of chips for which the surface topography is characterized during this production. For example, a reduction in the resolution of data by a factor of 2 can reduce the computer time by a tenth of a second, which is useful when this processing is repeated for example several thousand times or several tens of thousand times per day.

In the case of a chip with an area between about 1 cm² and 2 cm², such as a microprocessor, the data resolution can be reduced by a factor equal to 16.

However, the reduction factor of the resolution that can be applied is chosen so as not to excessively attenuate or eliminate unwanted topographic contributions that will be eliminated by the second fitting applied later. However, these unwanted topographic contributions are usually at low frequency, so that a large reduction in the resolution can be applied thereby giving a large increase in the speed.

Therefore the parameters of this reduction in the data resolution are adapted to the context and usage constraints of the characterization method. The value of the applied reduction of the resolution may be chosen and applied in exactly the same way for a particular family of measurements. Furthermore, the factor applied for this reduction in resolution is also chosen as a function of the acquisition size made and therefore the initial number of measurement points.

As a variant, this fourth data resolution reduction step 108 is not necessarily applied, depending on the context and computer capacities.

A fifth step 110 is applied after the fourth step 108 to reduce the data resolution (or directly after the third step 106 of filtering if the fourth step 108 is not used), to determine fitting coefficients for data output from the fourth step 108 (or for data output from the third step 106). The third step 106 of filtering made previously makes it easier to discriminate between patterns that are not to be fitted and unwanted topographic contributions that are to be fitted due to the smaller number of points representing the patterns that are not to be fitted. This fifth step 110 does not flatten the data in any way, but the purpose of this step is to determine the coefficients of a fitting equation (for example a polynomial) starting from filtered data, the resolution of which may have been reduced. FIG. 4 shows a curve 111 graphically representing the polynomial for which the coefficients were obtained by application of this fifth step 110 of fitting, in this case applied with order 2.

As for the first fitting 104 made previously, the order n of the polynomial used for this step is chosen as a function of the size of the zone to be fitted and the sample type. This order n is greater than or equal to the order m of the equation used for the first fitting 104. This fifth step 110 may for example be applied using a polynomial with order n between 1 and 10, or even with a polynomial with order n greater than 10 if possible depending on calculation capacities and/or the execution time.

An equation other than a polynomial can also be used, for example a sine or cosine type equation as described above with order n greater than or equal to m.

The coefficients determined during the fifth step 110 are then used to perform a sixth step 112 corresponding to a second fitting of data output from the first fitting 104 applied from the equation formulated with these coefficients. This second fitting 112 flattens the topographic data again in order to remove the geometric shape defined by the equation for which the coefficients were determined during application of the fifth step 110. The data output from this second fitting 112 are shown in FIG. 5.

The result obtained is thus topographic data for the characterized surface in which unwanted topographic contributions are eliminated more precisely than with a single data fitting step. Therefore, the global fitting made by application of steps 104 to 112 of the process eliminates unwanted topographic contributions, while having no effect or little effect on variations related to patterns on the characterized surface.

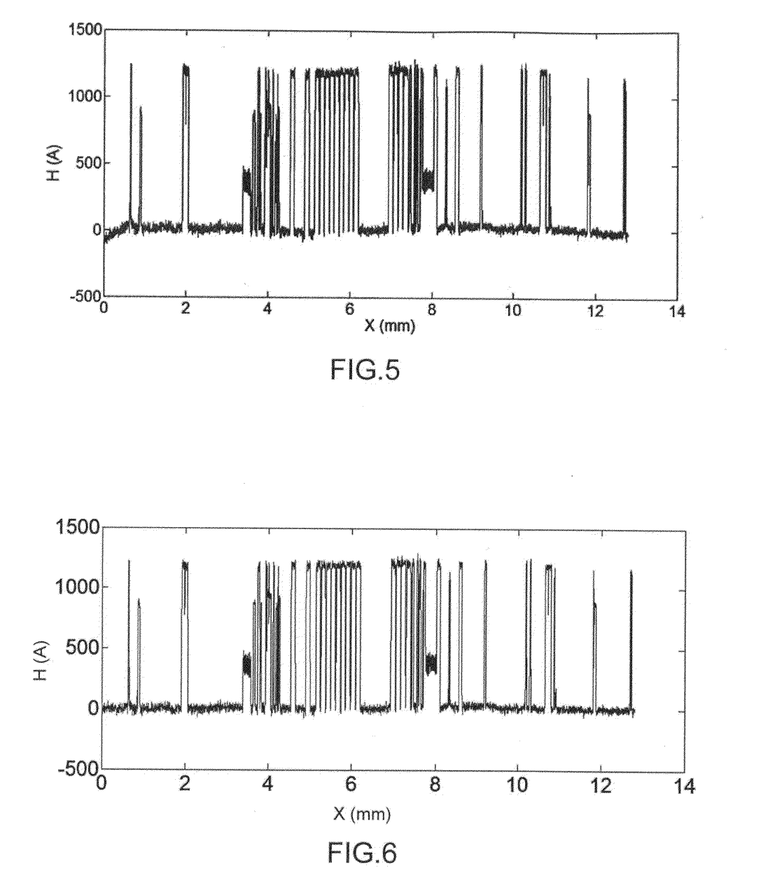

Steps 106 to 112 can be repeated once or several times starting from data obtained in the sixth step 11, to further optimise the result. During the repeated application(s) of step 106 to filter the height, the process applies a filter to eliminate even more points representing patterns on the characterized surface, so that all points representing patterns can be eliminated during the repeated filter operation(s) 106. This flattens data once again by fitting with an arbitrary degree without any danger of fitting the patterns. The number of iterations of steps 106 to 112 is adapted to the context and constraints in which the characterization method is applied, and can be chosen and applied in exactly the same way for a particular family of measurements. FIG. 6 shows the topographic data obtained after one iteration and with a sixth step 112 applied with a polynomial with order n=10.

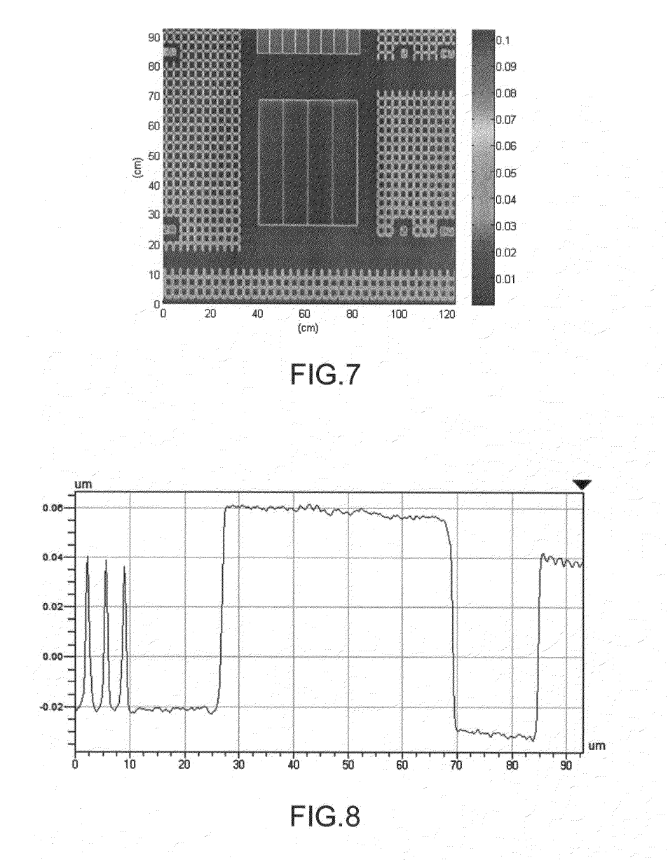

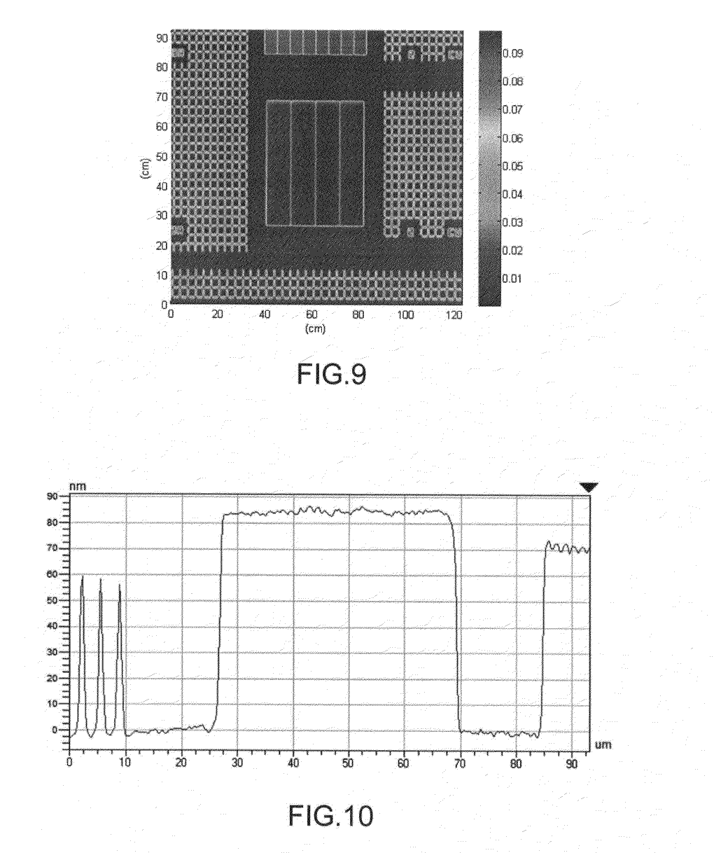

FIG. 7 shows an example of 3D topography measurement data obtained after application of a method for characterization of the surface topography of a CMOS type electronic chip made in 65 nm technology during which a single fitting (with an order 2 polynomial) of the data is made. FIG. 8 shows the profile (2D topography measurement) corresponding to the plot represented by the arrow in FIG. 7. In comparison, FIG. 9 shows data (3D topography measurement) obtained after application of a topography characterization method to this same surface, during which steps 102 to 112 described above are used, with a first fitting made with an order m=1 polynomial, and a second fitting made with an order n=2 polynomial, steps 102 to 112 being applied only once, with no additional iteration of these steps. FIG. 10 shows the profile (2D topography measurement) corresponding to the plot represented by the arrow in FIG. 9. In particular, by comparing FIGS. 8 and 10, it can be seen that application of the method containing steps 102 to 112 eliminated unwanted topographic contributions much more efficiently (in particular see the slopes present for x>30 μm in FIG. 8).

Although the method described above is particularly advantageous for topography measurements made over large areas (distance longer than or equal to about 1 mm for a 2D measurement or area larger than or equal to about 1 mm² for a 3D measurement), this method can also be applied for topography measurements made on smaller areas.

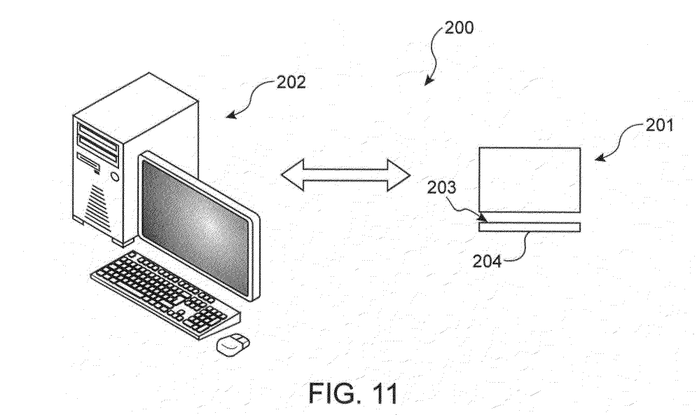

The surface topography characterization method may be applied by a permeation estimating device 200 like that shown for example in FIG. 11. The device 200 comprises a measurement device 201 like that previously described (mechanical profilometer, AFM, confocal microscope, interferometric microscope, etc.) in order to make topographic measurements of a surface 203 to be characterized (in this case a surface 203 of an electronic chip 204) and one or several computers 202 or calculation units capable of forming an inputs/outputs interface with the operator. The computer(s) 202 is (are) connected to the measurement device 201 particularly to control the measurement device 201, receive measurement data output by the measurement device 201 and then perform the steps of the characterization method described above.

In the examples described above, the surface topography characterization method is used to characterize surfaces of microelectronic devices. However, this method can also be used for other fields such as mapping, for example earth mapping. This method could be used for example with measurements made at the scale of a country, for example over an area of 550 000 km², with a spatial sampling of 0.1 km² in order to see the steepest mountainous terrain. For example, measurements made for this type of application could be made by satellite.

1. A method for characterization of a surface topography, comprising at least application of the following steps:
measurement of the surface topography;
first fitting of data output from the measurement of the surface topography, made from an order m first equation;
filter data output from application of the first fitting, eliminating some of the data output from application of the first fitting the values of which are greater than a maximum value or less than a minimum value;
determine the data fitting coefficients for data output from the application of filtering, from an order n second equation;
second fitting of data output from application of the first fitting, made from the order n second equation and coefficients determined by application of the previous determination step;
n and m being positive integers greater than or equal to 1 and such that n≧m.

2. The method according to claim 1, in which the surface corresponds to at least part of a face of an electronic chip comprising patterns.

3. The method according to claim 1, in which the measurement of the surface topography is made in two dimensions over a length greater than or equal to about 1 mm or such that the ratio between said length and a spatial sampling value of the measurement is greater than or equal to about 1 000, or in three dimensions over an area greater than or equal to about 1 mm² or such that the ratio between said area and a spatial sampling value of the measurement is greater than or equal to about 1 000 000.

4. The method according to claim 1, in which at least one of the first fitting and the determination of the coefficients is made by regression.

5. The method according to claim 1, in which at least one of the first equation and the second equation is polynomial or sine or cosine type equation.

6. The method according to claim 1, in which the parameters n and m are such that m∈[1,·10] or n∈[1,·20].

7. The method according to claim 1, also comprising the use of a step to reduce the resolution of data output from the filtering step between the filtering step and the step to determine fitting coefficients, the step to determine fitting coefficients being applied using data with a reduced resolution.

8. The method according to claim 7, in which the reduction of the data resolution is applied with a reduction factor of between about 2 and 100.

9. The method according to claim 1, in which the steps of the method between the filtering and the second data fitting are applied one or several times using data output from a previous application of the second data fitting.

10. The method according to claim 1, in which the measurement of the surface topography is made in two or three dimensions using at least one of the following measurement techniques: mechanical profilometry, atomic force microscopy, interferometric microscopy, confocal microscopy.

11. A device for characterization of a surface topography comprising a device for measuring the surface topography and one or several computers or calculation units for performing the steps of the method according to claim 1.
